(19) United States
(12) Patent Application Publication
(10) Pub. No.: US 2020/0323128 A1
(43) Pub. Date: Oct. 15, 2020

(54) DEVICE FOR REMOVING LEAVES FROM ROOT CROPS

(71) Applicant: DEWULF NV, ROESELARE (BE)

(72) Inventors: Joeri Van Iseghem, INGELMUNSTER (BE); Gert De Boe, LOCHRISTI (BE)

(73) Assignee: DEWULF NV

(21) Appl. No.: 16/840,482

(22) Filed: Apr. 6, 2020

(30) Foreign Application Priority Data
Apr. 12, 2019 (EP) 19168995.9

(51) Int. Cl. A01D 23/04

(52) U.S. Cl. CPC A01D 23/04

(57) ABSTRACT

The invention relates to a device for removing leaves from root crops, such as carrots, comprising sets of bars and sets of bearing blocks, each of the bars having ends rotatably mounted to their respective bearing blocks, thereby enabling simultaneous rotation, and each bar being substantially rotationally symmetrical with respect to rotation over 180° around a symmetry axis. Each bar is further releasably fixable in the device, such that when fixed in the device in a first position, each bar is releasable, is turnable over 180° around the symmetry axis for placing it in a second position, and is fixable in the second position in the device. The invention also relates to a bar for such a device, to a harvesting machine comprising such a device, and to a method for maintenance of such a device.

### FIELD OF THE INVENTION

This application relates generally to a device for removing leaves from root crops, such as carrots, beetroots, sugar beets, radishes, turnips, or the like, and, in particular, a device comprising sets of bars and sets of bearing blocks, the bars of each set of bars having ends being rotatably mounted to their respective bearing blocks, thereby achieving simultaneous rotation. The device in its various aspects can be used for a variety of functions, including, but not limited to, harvesting cotton and like plants, harvesting and husking ears of corn, and harvesting corn and other similar stalk crops.

### BACKGROUND

Various devices for harvesting crops and, in particular, devices for removing leaves from root crops, are generally known in the art. Such devices are described in, for instance, U.S. Pat. Nos. 3,307,599 and 3,863,555. These devices may be integrated into harvesting machines in order to remove leaves from root crops.

In harvesting machines, root crops generally enter between two sets of bars of the device while these bars are rotated. Bearing blocks are associated with both sets of bars and, in order to rotate the bars, the bearing blocks of both sets are also rotated such that each of the bars travels in an elliptical path relative to each other. In particular, the bars of a first set move in one direction while the bars of a second set move in counter-rotation relative to the bars of the first set. Each of the sets of bars rotates in its respective bearing block in order to maintain orientation with respect to the root crops. The leaves of the root crops are grasped by the bars, move forward, and are sheared or teared from the rest of the root crops. The roots themselves drop down from the device, while the leaves are moved forward in the device.

The cross sections of each set of bars may have different forms. Depending on the type of root crops and depending on the part of the leaves that are to be removed from the rest of the root crops, the bars may be rounded bars with a cross section and have an elliptical, or nearly elliptical form. The bars may also take the form of knives with knife blades.

However, the sets of bars described above are highly subject to wear and tear. In order to extend the lifespan of these bars, different solutions have been considered in the art. Manufacturing the bars of a material that is less prone to wear and tear has also been considered, but this solution is expensive. One solution is to construct only a part of each bar from a more durable material, such as described in, for example, GB Patent No. 396,560.

Given the foregoing, there exists a need to provide an alternative solution to extend the lifespan of the bars of devices that remove leaves from root crops.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description.

In general, the present invention is directed to a device for removing leaves from root crops, such as carrots, beetroots, sugar beets, radishes, turnips, or the like, and, in particular, a device comprising sets of bars and sets of bearing blocks, the bars of each set of bars having ends being rotatably mounted to their respective bearing blocks, thereby achieving simultaneous rotation. Each bar is substantially rotationally symmetrical with respect to rotation over 180° around a symmetry axis and is releasably fixable in the device, such that when fixed in the device in a first position, each bar is releasable, is turnable over 180° around the symmetry axis for placing it in a second position, and is fixable in this second position in the device.

In addition, the present invention in at least one embodiment relates to a bar for the aforementioned device. The invention in at least one embodiment further comprises a harvesting machine comprising the aforementioned device.

Embodiments of the present invention may also be directed to a method for maintenance of the aforementioned device.

One of skill in the art will recognize that the greatest wear during operation of devices for removing leaves from root crops typically occurs in a zone that covers a first part of the device where the root crops enter the device. The cross section of the bars decreases in this zone and the bars become thinner. If a bar in this zone is too worn, the current state-of-the art solution is to replace the bar. This bar may be turned over 180° and used again. Turning over of worn bars was previously not possible in the prior art. The bars of a device according to various embodiments of the present invention are constructed such that each bar is substantially rotationally symmetrical with respect to 180° around a symmetry axis and is releasably fixable, thereby enabling reuse of the bars before replacing them. The lifespan of each bar is therefore minimally increased by at least a factor of 2.

It should be appreciated that each of the bars may be exactly rotationally symmetrical or deviate slightly therefrom, but in any case, each of the bars can be turned 180° and reused.

It should further be appreciated that such bars, or parts thereof, may be made from a more durable material than with bars of prior art devices, such that the lifespan of these bars can be even further increased.

In at least one embodiment of the invention, each set of bars is releasably fixable. To achieve this, the bearing blocks associated with each set may also be releasably fixable in the device. A skilled artisan will appreciate that each of the bars in a set of bars will typically wear to the same extent. Therefore, instead of demounting and mounting each bar separately, each set of bars may be demounted and mounted as a whole. Both the bars and bearing blocks of a given set may then be disassembled from the device, turned over 180°, and reassembled in the device. It should be appreciated that this is faster than disassembling and assembling each and every bar separately, thereby resulting in less time spent and lower costs.

In order to enable the bearing blocks to be releasably fixable, the bearing blocks of each set may be interchangeable and/or identical to each other. One or more bearing blocks of a first set may further be interchangeable and/or identical with one or more bearing blocks of a second set. Additionally, all of the bearing blocks installed in a device may be identical to each other. It should be appreciated that any identity in bearing blocks results in various advantages, including, for example, less spare parts necessary for maintenance of the bearing blocks. It should further be appreciated that the bars of each set are interchangeable and/or identical to each other. Even further, all of the bars installed in a device may be identical to each other.

In at least one embodiment of the present invention, the bars are releasably fixable both individually and as part of their respective set. Therefore, if an individual bar is defective, it can still be replaced individually.

In at least one aspect of the device according to the present invention wherein each bar comprises a knife blade, the cross-section of this knife blade has line symmetry with respect to the symmetry axis.

In a device according to one or more embodiments of the invention, the mutual position of the sets of bars is adjustable, and the device further comprises one or more adjusters for adjusting the mutual position.

The one or more adjusters may comprise distance adjusters for adjusting a position of the bearing blocks at a first end of the sets towards and away from each other, and/or distance adjusters for adjusting a position of the bearing blocks at a second end of the sets towards and away from each other.

One of skill in the art will appreciate that, when the bars of a device are worn out and the cross-section of the bars is the same, or almost the same, but is narrower when compared to new bars, the bars can be placed closer together using the distance adjusters. The same bars can therefore continue to be used and the bars may additionally be turned over 180° and reused again. Theoretically, this process can continue until the cross section of the bars has become too thin to adequately perform their function. It should thus be appreciated that the lifespan of each bar may be increased by a large factor.

The one or more adjusters can also more specifically comprise angle adjusters for adjusting the rotational position of the bearing blocks with respect to each other. More specifically, the position of the bearing blocks can be adjusted relative to each other in such a way that the bars of both sets can be positioned either in phase with each other or out of phase with each other.

It should be appreciated that the term “in phase,” at least as used herein, refers to, when the sets of bars are rotated, bars of both sets coinciding with a line intersecting their axes of rotation at the same time. It should further be appreciated that the term “out of phase,” at least as used herein, refers to, when the sets of bars are rotated, bars of both sets coinciding with a line intersecting their axes of rotation at different times.

The invention in its various embodiments further comprises a bar for a device for removing leaves from root crops, the bar comprising cranked ends, each cranked end comprising a mounting pin for mounting the bar in the device, wherein the bar is rotationally symmetrical with respect to rotation over 180° around a symmetry axis. Such a bar may be used as a bar in a device according to one or more embodiments of the invention, as described above herein.

Embodiments of the present invention further comprise a harvesting machine for harvesting root crops, the harvesting machine comprising a device for removing the leaves from the root crops according to one or more embodiments of the invention, as described above herein.

The invention in at least one embodiment additionally comprises a method for maintenance of a device for removing the leaves from root crops, the device being a device according to one or more embodiments of the invention, as described above herein, wherein at least one bar is mounted in the device in a first position, and/or is turned over 180° with respect to the symmetry axis and mounted in a second position.

In one or more embodiments, the device is a device with bearing blocks, the bearing blocks being releasably fixed in the device. The bearing blocks to which at least one bar is mounted may be demounted and mounted for the purpose of demounting and mounting the at least one bar. This at least one bar may therefore be either separately demounted from the bearing blocks and mounted again, or can be demounted and mounted together with other bars of the same set of bars and the corresponding bearing blocks.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art.

FIG. 1 illustrates, in a side view, part of a carrot harvester.

FIG. 2 illustrates, in a perspective view, a device for removing leaves from carrots in the carrot harvester of FIG. 1.

FIG. 3 illustrates, in a perspective view, a first set of the device of FIG. 2.

FIG. 4 illustrates the knives of the sets of the device of FIG. 2, in cross-section and positioned out of phase with each other.

FIG. 5 illustrates the knives of the sets of the device of FIG. 2, in cross-section and positioned in phase with each other.

FIG. 6 illustrates the device of FIG. 2 in a detailed cross-section at a height of a first end of the first set.

FIG. 7 illustrates the device of FIG. 2 in a detailed cross-section at a height of the second end of the first set.

FIG. 8 illustrates, in a perspective view, a knife of the device of FIG. 2.

FIG. 9 illustrates, in a side view, the knife of FIG. 8.

FIG. 10 illustrates, in a front view, the knife of FIG. 8.

FIG. 11 illustrates the knife of FIG. 8 in a cross-section cut through the knife blade, according to cut DD′, as indicated in FIG. 12.

FIG. 12 illustrates, in a top view, the knife of FIG. 8.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a,” “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

Generally, the present invention is directed to a device for removing leaves from root crops, such as carrots, beetroots, sugar beets, radishes, turnips, or the like, and, in particular, a device comprising sets of bars and sets of bearing blocks, the bars of each set of bars having ends being rotatably mounted to their respective bearing blocks, thereby achieving simultaneous rotation. Each bar may be substantially rotationally symmetrical with respect to rotation over 180° around a symmetry axis and being releasably fixable in the device, such that when fixed in the device in a first position, each bar is releasable, is turnable over 180° around the symmetry axis for placing it in a second position, and is fixable in this second position in the device.

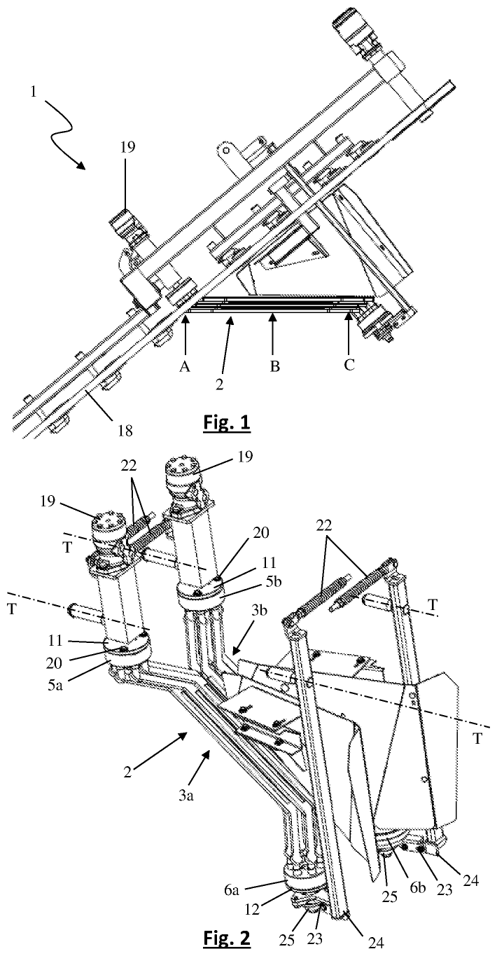

Turning now to FIG. 1, an illustrated harvesting machine (1), which is a carrot harvester, is shown. It should be appreciated that the invention is not limited to carrot harvesters in particular, and that the illustrated carrot harvester is used as a non-limiting example. The invention in its various embodiments is therefore applicable to similar harvesters for harvesting other types of root crops.

In the case of the harvesting machine (1), carrots are removed from the soil with plow blades, which are not illustrated. These carrots are then moved upwards between two conveyor belts (18) towards the device (2) for removing the leaves from these carrots. The device (2) shears or tears the leaves from the rest of the carrots, which drop down. The leaves are further moved forward by the same conveyor belts (18).

The device (2) comprises a first set (3a) of bars (4a) and bearing blocks (5a, 6a) and a second set (3b) of bars (4b) and bearing blocks (5b, 6b).

In the various figures, the bars (4a, 4b) are provided as knives (4a, 4b). Each knife (4a, 4b) comprises a knife blade (17) and cranked ends (16). Each cranked end (16) is provided with a mounting pin (8) for mounting the knife (4a, 4b) in the respective bearing block (5a, 5b, 6a, 6b).

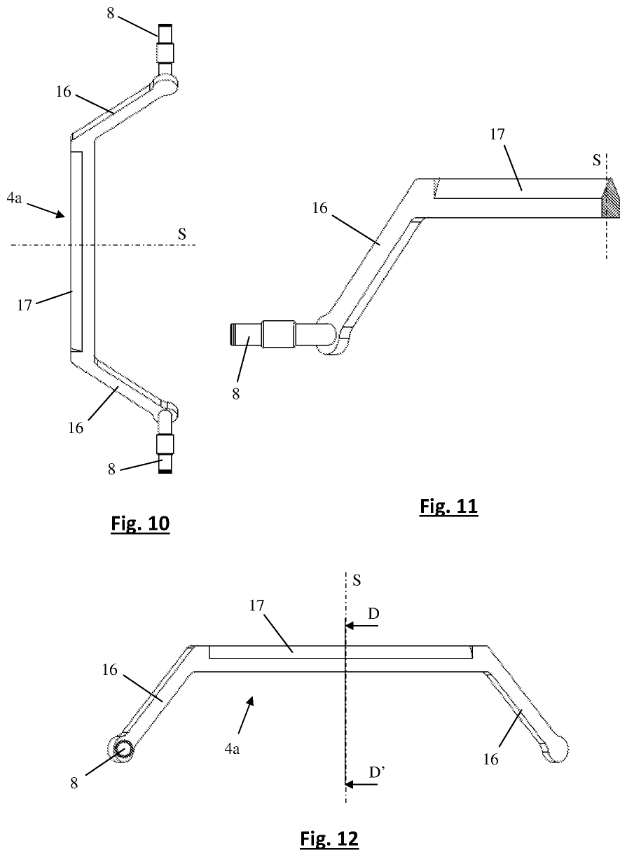

As can be seen in FIGS. 10-12, each knife is rotationally symmetrical with respect to rotation over 180° around a symmetry axis (S) and the cross-section of the knife blade (17) thereof is line symmetrical with respect to this symmetry axis (S).

Further, all knives (4a, 4b) illustrated in the various figures are identical, although one of skill in the art will appreciate that such identity is not mandatory.

The knives (4a, 4b) of each set (3a, 3b) have ends that are rotatably mounted to their respective bearing blocks (5a, 5b, 6a, 6b) of the corresponding set (3a, 3b), thereby enabling simultaneous rotation.

The bearing blocks (5a, 5b, 6a, 6b) comprise a central bore (9) and secondary bores (10), which are equally spaced around the central bore (9). The secondary bores (10) extend parallel to the central bore (9).

The mounting pins (8) of the knives (4a, 4b) are journaled in the secondary bores (10). These mounting pins (8) are rotatably mounted in these secondary bores (10) by means of roller bearings (15).

The bearing blocks (5a, 5b) at the top of the bars (4a, 4b) are driving bearing blocks (5a, 5b). A driving shaft (13) which can be driven by means of a driver (19), is journaled and secured in the central bore (9) of each driving bearing block (5a, 5b). This driving shaft (13) is rotatably mounted in the device by means of a bearing attachment (21).

The bearing blocks (6a, 6b) at the bottom of the bars (4a, 4b) are driven bearing blocks (6a, 6b). A rotatable shaft (14) is journaled and secured in the central bore (9) of each driven bearing block (6a, 6b). This rotatable shaft (14) is rotatably mounted in the device by means of a bearing attachment (25).

It should be appreciated that all of the bearing blocks (5a, 5b, 6a, 6b) illustrated in the various figures are identical, but such identity is not mandatory.

At both ends, a cover plate (11, 12) is fixed to the respective bearing blocks (5a, 5b, 6a, 6b) by one or more mechanisms, including, as a non-limiting example, bolts (20), in order to protect the roller bearings (15) from dirt. Both cover plates (11, 12) can be fixed to the respective shafts (13,14) by one or more mechanisms, including, as a non-limiting example, by welding. Alternatively, these cover plates (11, 12) could be fixed to the respective bearing blocks (San 5b, 6a, 6b) by means of any other mechanism known in the art, e.g., press fitting.

In order to remove the leaves from the carrots with the device (2), the carrots enter between the bars (4a, 4b) of the device (2) while these bars (4a, 4b) are rotated. In order to rotate the bars (4a, 4b), the driving bearing blocks (5a, 5b) of both sets (3a, 3b) of bars (4a, 4b) and the driven bearing blocks (6a, 6b) are rotated around their rotation axis (Rₘ), such that the bars (4a, 4b) travel in an elliptical path. The bars (4a) of the first set (3a) move in one direction, while the bars (4b) of the other set (3b) move in another direction that is in counter-rotation to the one direction. The bars (4a, 4b) rotate in the bearing blocks (5a, 5b, 6a, 6b) around their rotation axis (Rₑ) to maintain their orientation with respect to the carrots.

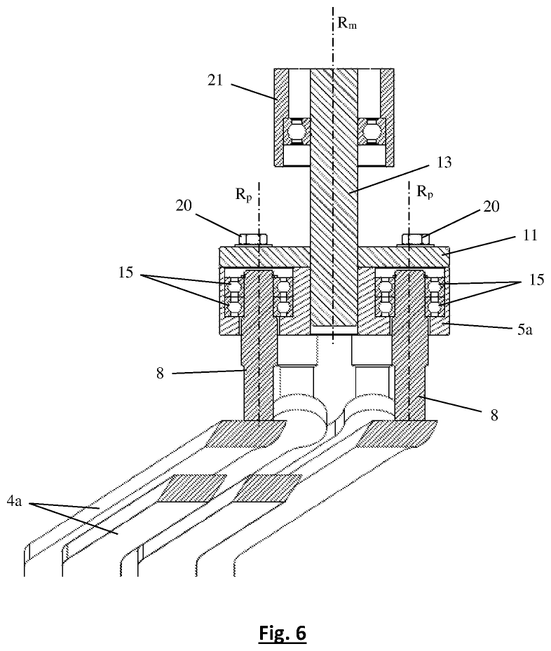

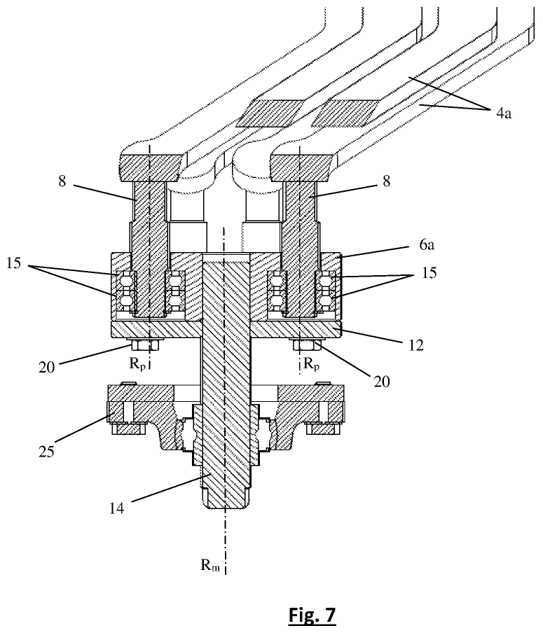

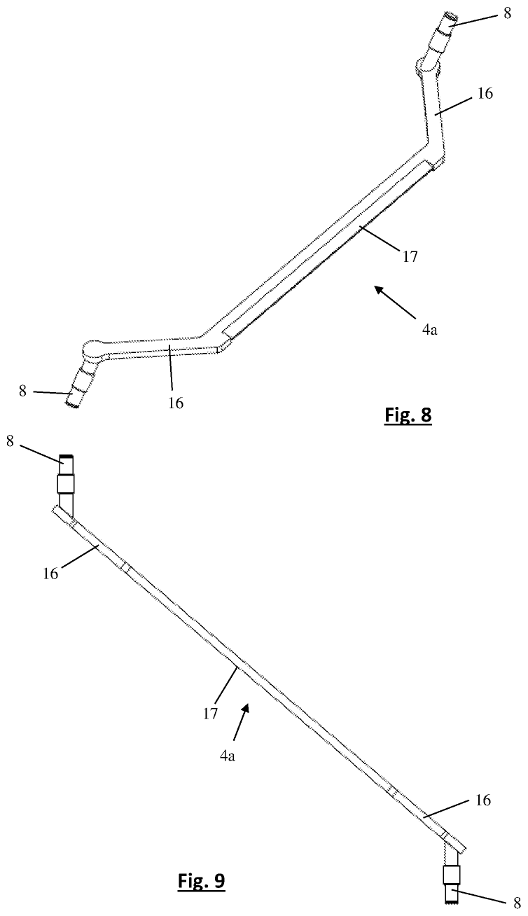

As illustrated in the various figures, the knives (4a) from the first set (3a) can be disassembled from the device (2) as follows. The bolts (23) and nuts with which the driven bearing block (6a) is mounted to a mounting frame (24) (see FIG. 2) are loosened. Thereafter, the rotatable shaft (14) and its bearing attachment (25) are rotated over 120°, so that they can be lowered without being hindered by the mounting frame (24). Then, the bolts (20) with washers (see FIG. 7) are removed from the cover element (12) of the driven bearing block (6a). The rotatable shaft (14) is then pulled out of the driven bearing block (6a), together with its cover element (12) and its bearing attachment (25). It is possible to provide this rotatable shaft (14) and/or its cover element (12) and/or its bearing attachment (25) with a gripper in order to enable removal from the rotatable shaft (14). The first set (3a) is rotated away from the second set (3b) so that the first set (3a) can be disassembled without being hindered by the mountings with which the second set (3b) is mounted. Then the bolts (20) with washers from the cover plate (11) of the driving bearing block (5a) (see FIG. 6) are loosened, such that the driving bearing block (5a) can be disassembled. The first set (3a) is disassembled together with this driving bearing block (5a).

The first set (3a) can then be turned over 180° such that the driving bearing block (5a) is lowered to take the place of the driven bearing block (5b) and vice versa. The first set (3a) is then mounted in the reverse order.

Alternatively, it is also possible only to demount one single knife (4a) from the first set (3a) individually from the bearing blocks (5a, 6a), turn this knife (4a) over 180°, mount this knife (4a) back in the bearing blocks (5a, 6a) and then to mount the whole set (3a) again.

The knives (4b) of the second set (3b) can be disassembled, turned, and mounted in a similar way.

In the mounted position, the mutual position of the sets (3a, 3b) is adjustable. The sets are resiliently suspended in the device (2) by means of springs (22) and rotatable around rotation axes T (see FIG. 2). If unwanted material, such as, for instance, a thick pile of leaves or a stone, enters between the knives (4a, 4b), the sets (3a, 3b) can be moved away from each other against the spring force created by the springs (22). It should be appreciated that the springs (22) are pressed in such that, when the unwanted material leaves, the sets (3a, 3b) are automatically returned to their initial position. This initial position between the sets (3a, 3b) can be adjusted by turning the counter nuts of these springs (22). These counter nuts function as distance adjusters. When the knives (4a, 4b) are worn out, the sets (3a, 3b) can be placed closer together by turning these counter nuts.

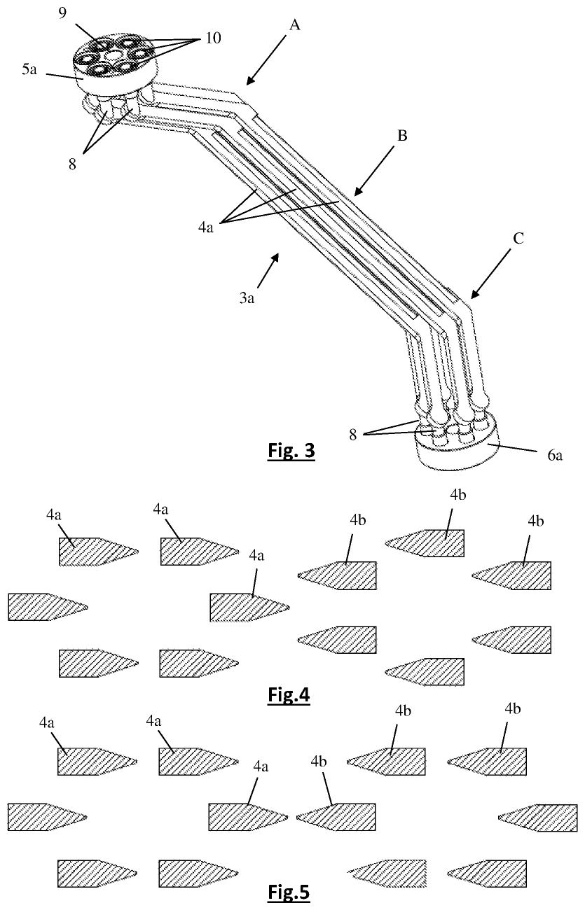

One of skill in the art will recognize that, during operation of the device (2), the greatest wear of the knives occurs in the zone between arrows A and B, as illustrated in FIGS. 1 and 3. By contrast, the zone between the arrows B and C on these figures is not as worn. Due to the wear, the cross section of the knife decreases and the knife becomes thinner. If the zone between the arrows A and B is too worn, the set (3a, 3b) can be demounted, turned, and remounted as described above. The part between the arrows A and B is then interchanged with the part between the arrows B and C, and vice versa. After continued use, the part between the arrows B and C will therefore be as worn as the part between the arrows A and B. The sets (3a, 3b) can then be placed closer together by turning the counter nuts of the springs (22). This process can then be repeated and, after further use, the sets (3a, 3b) can be demounted, turned. and remounted again.

The sets (3a, 3b) can furthermore be rotationally positioned relative to each other such that the knives (4a, 4b) can be positioned either out of phase with each other (see FIG. 4), or in phase with each other (see FIG. 5). Such positioning is achieved through the cover plates (11, 12), which comprise slotted holes in which the bolts (20) for fixing these cover plates (11, 12) are inserted. These slotted holes are not visible in the drawings. However, it should be appreciated that the slotted holes can be sufficiently long such that they can serve as angle adjusters with which the knives (4a, 4b) can be positioned either out of phase with each other, or in phase with each other.

1. A device for removing leaves from root crops, the device comprising:
sets of bars; and
sets of bearing blocks,
wherein each bar in each set of bars comprises ends rotatably mounted to its respective bearing blocks in each set of bearing blocks, thereby enabling simultaneous rotation, and
wherein each bar in each set of bars is substantially rotationally symmetrical with respect to rotation over 180° around a symmetry axis and is releasably fixable in the device such that, when fixed in the device in a first position, each bar in each set of bars is releasable, is turnable over 180° around the symmetry axis for placing each bar in each set of bars in a second position, and is fixable in the second position in the device.

2. The device of claim 1, wherein each bearing block in each set of bearing blocks is releasably fixable in the device and is able to releasably fix each bar in each set of bars.

3. The device of claim 2, wherein each bearing block in each set of bearing blocks is interchangeable.

4. The device of claim 1, wherein each bar in each set of bars is interchangeable.

5. The device of claim 1, wherein each bar in each set of bars comprises a knife blade, and wherein a cross-section of the knife blade is line symmetrical with respect to the symmetry axis.

6. The device of claim 1, wherein a mutual position of the sets of bars is adjustable, and further comprising one or more adjusters for adjusting the mutual position.

7. The device of claim 6, wherein the one or more adjusters further comprises:
distance adjusters for adjusting a position of each bearing block at a first end of the sets of bars towards and away from each other, and/or
distance adjusters for adjusting a position of each bearing block at a second end of the sets of bars towards and away from each other.

8. The device of claim 6, wherein the one or more adjusters further comprises one or more angle adjusters for adjusting a position of the sets of bearing blocks such that the sets of bars can be positioned either in phase with each other or out of phase with each other.

9. A bar for a device for removing leaves from root crops, the bar comprising:
cranked ends, each cranked end comprising a mounting pin for mounting the bar in the device,
wherein the bar is rotationally symmetrical with respect to rotation over 180° around a symmetry axis.

10. The bar of claim 9, wherein the device is a device according to claim 1.

11. A harvesting machine for harvesting root crops, the harvesting machine comprising:
a device for removing leaves from root crops, wherein the device is a device according to claim 1.

12. A method for maintaining a device that removes leaves from root crops, the method comprising:
mounting at least one bar in a device that removes leaves from root crops in a first position;
demounting the at least one bar from the device;
turning the at least one bar over by 180° with respect to a symmetry axis;
mounting the at least one bar in the device in a second position.

13. The method of claim 12, wherein the device further comprises at least one set of bearing blocks, and wherein the at least one bar is mounted to each bearing block in the at least one set of bearing blocks.

14. The method of claim 13, further comprising:
demounting the at least one set of bearing blocks, thereby demounting the at least one bar; and
mounting the at least one set of bearing blocks, thereby mounting the at least one bar.

15. The method of claim 14, wherein the at least one bar is demounted and mounted together with its corresponding bearing blocks in the at least one set of bearing blocks.
